(19) United States
(12) Patent Application Publication
(10) Pub. No.: US 2015/0102963 A1
(43) Pub. Date: Apr. 16, 2015

(54) DIFFERENTIAL SIGNAL STRENGTH DETERMINATION SYSTEMS AND METHODS

(71) Applicant: David L. Marshall, North Salt Lake City, UT (US)

(72) Inventor: David L. Marshall, North Salt Lake City, UT (US)

(21) Appl. No.: 14/512,384

(22) Filed: Oct. 11, 2014

Related U.S. Application Data
(63) Continuation of application No. PCT/US14/60189, filed on Oct. 11, 2014.
(60) Provisional application No. 61/889,419, filed on Oct. 10, 2013.

(51) Int. Cl. G01S 3/14

(52) U.S. Cl. CPC G01S 3/14
USPC 342/449; 342/417

(57) ABSTRACT

A differential signal strength direction determination systems (DSSDDS) may be programmed to provide an output that will enable an individual to determine a direction in which a source of a signal of interest is located with increased accuracy. The programming of the DSSDSS may improve accuracy by consolidating corresponding parts of a signal over time, by modifying a signal strength scale to enable an individual to better discern between the strengths of various signals and/or by providing a user-perceptible output that enables an individual to better discern between the strengths of various signals.

### CROSS-REFERENCE TO RELATED APPLICATIONS

A claim to the benefit of the Oct. 10, 2013 filing date of U.S. Provisional Patent Application No. 61/889,419 (“the '419 Provisional Application”) is hereby made pursuant to 35 U.S.C. §119(e). The entire disclosure of the '419 Provisional Application is hereby incorporated by reference.

This application is also a continuation of International patent application no. PCT/US14/60189, filed on Oct. 11, 2014 and titled DIFFERENTIAL SIGNAL STRENGTH DETERMINATION SYSTEMS AND METHODS, the entire disclosure of which is hereby incorporated by reference.

### TECHNICAL FIELD

This disclosure relates generally to differential signal strength direction determination systems and, more specifically, to differential signal strength direction determination systems that are programmed to provide an output that will enable an individual to determine a direction in which a source of a signal of interest is located with increased accuracy.

### RELATED ART

Radio-based direction finding has a history dating back to the early days of radio. Many different technologies have been used to determine direction toward the source of a signal of interest (i.e., a radio frequency, or RF, signal). These technologies include techniques based on physical properties of the incoming signal, or radio waves. Other implementations by which the direction of the source of a signal may be determined include techniques such as differential time of arrival (DTOA); phase or frequency differential detection utilizing a plurality of antennas in an array, including pseudo-Doppler systems; and proximity detection. Radio-based differential signal strength direction determination systems (DSSDDS) are most appropriate in situations where it is impractical to determine the location of a subject by way of the global positioning system (GPS) or another satellite-based system, and simply transmit the subject's coordinates to the party looking for the subject.

Radio-based DSSDDSs are especially suitable for using small, weak beacon transmitters to locate subjects over relatively long distances (e.g., line of sight distances, a few miles, etc.), and may be very portable. Such systems have become widely used by biologists to track wild animals, by hunters tracking hounds and falcons, and by search and rescue teams locating lost individuals. They are usually used in the very high frequency (VHF) and the ultra-high frequency (UHF) ranges of the electromagnetic spectrum to optimize radio signal propagation while enable the use of reasonably sized directional antennas.

However, to be effective, conventional DSSDDSs typically require the operator to possess both skill and experience to find the direction or location of the source of a signal of interest. Even then, the use of conventional DSSDDSs may take an undesirably long duration of time to operate and to enable an individual to determine the direction. They usually give little or poor indication of the range to the transmitter. They often do not work over long enough distances. Often, the determined direction is not sufficiently accurate.

The directional antennas of receiving devices of existing DSSDDSs are typically pointed in a plurality of different directions to enable an individual to determine the direction from which a signal of interest (e.g., from a transmitter of the DSSDDS, etc.) originates. More specifically, an individual typically moves the directional antenna in a plurality of directions. This often involves moving the directional antenna along an arcuate path, which points the directional antenna in a plurality of different directions. The size of the arc may vary from a few degrees up to a complete 360° revolution, or even more than one revolution. Such movement may include back and forth arcuate movement of the directional antenna. While moving the directional antenna, the individual may manually adjust the RF gain, volume and/or attenuation of the receiving device so that the strength of the signal of interest level is corrected to be within both the narrow window of the RF dynamic range of the receiver, as well as the limited range of the indicator providing the user-perceptible output. Using either visual indication from a meter, or the audible tonal output from a speaker, the individual may be able to determine the strongest signal and, thus, the general direction of the source of the signal of interest (i.e., the transmitter).

With some understanding of the general direction toward the source of the signal of interest, the individual again moves the directional antenna slowly along an arcuate path. This time, the length of the arcuate path may be smaller. The individual makes note of the signal strength, which is again presented by the tonal output of a speaker or the visual indication provided by the output of a meter. The peak signal strength will correspond to the azimuth at which the directional antenna is in line with the highest amplitude of the signal of interest, and is indicated by a maxima in volume output or visual indication. This maxima in volume or visual indication is arbitrary, and is dependent upon the individual's manual adjustments to the receiving device.

If the strength of the signal from the transmitter changes (e.g., by changes in the location of the transmitter, or displacement differentials between the receiving device and the transmitter; by rapid changes in RF wave propagation (multipath); by non-constant environmental factors such as RF noise sources; etc.), the individual must constantly re-adjust the RF gain, volume or attenuation of the receiving device to keep the signal strength within a narrow range where differences in signal strength can be perceived by the individual (e.g., audibly or visually).

Typically, as the individual gets nearer to or farther away from the transmitter, he or she must repeat the direction finding process.

In all the actions described above, the individual is typically very preoccupied with the systems of the receiving device and is distracted from other tasks he or she must perform, such as navigation. The user may not only be preoccupied with adjusting the systems of the receiving device, but also with interpreting the results. He or she must remember both the signal strengths and their corresponding directions.

Furthermore, when a receiving device receives the signal of interest from a remote transmitter, the receiver produces an audible sound that varies in amplitude in direct proportion to the strength of the incoming signal. For an individual to discern the strength of that signal, the sound generated by the receiver must be detectable by the human ear. If the pulses are long enough in duration to be heard by an individual while operating the receiver (typically greater than 20 ms), they must also be spaced out far enough to reduce the drain on the battery of the transmitter. Spreading out pulses in a manner that preserves battery life typically requires a certain minimum period of time for the user to acquire enough pulses in enough directions to determine the correct direction, slowing down the process. In such a given period of time, the limited number of pulses limits the sound that the user can evaluate, which also reduces the accuracy of the result.

A more serious impediment to accuracy with which such a system may determine the direction in which a signal originates is that the user must typically make determinations of perceived signal strength based on the amplitude of the audio generated by the speaker. As the human ear's sensitivity to changes in amplitude is limited, the usable directivity of this kind of prior art implementation of a radio-based DSSDDS is limited.

The ranges of amplitudes over which the varying signal strength levels can be utilized by existing radio-based DSSDDSs are also limited. For example, the variance in minimum signal strength to maximum signal strength that can be effectively detected without manual intervention by the user (e.g., by adding input attenuation, adjusting gain, adjusting audio volume, etc.) is at most 20 dB to 30 dB. The same limitations apply when using a visual signal strength meter comprised of an indicator whose movement, intensity or segments change intensity in direct proportion to the amplitude of the signal.

Interpretation of the strength of a signal based on weak signals that vary in amplitude due to noise or interference and varying polarizations of the signal while discerning signals generated by the transmitter from false signals that may be present due to multi-path reflections and fading can require considerable mental computation. The mental computation required to operate existing radio-based DSSDDSs, as well as the possibility that other tasks will distract the user may increase the likelihood of error involved with efforts to interpret differences in an output that corresponds to a signal as the orientation of a directional antenna changes and, thus, reduce the effectiveness of existing radio-based DSSDDSs. In many cases, only very skilled users can actually successfully use an existing radio-based DSSDDS to locate a subject carrying a transmitter.

Some radio-based DSSDDSs have been developed that use digital technology to assist the individual operating the receiver of such a system. For example, the receiver of such a DSSDDS may automatically tune the signal or employ filters and detectors to artificially generate and output audible tones and/or visual indicators. However, most or all of the above-described limitations remain.

### SUMMARY

This disclosure relates generally to DSSDDSs and, more specifically, to DSSDDSs that are configured to increase the accuracy with which an individual may use a receiving device to locate a transmitter, as well as a subject of interest carrying the transmitter. Thus, in various embodiments, a DSSDDS according to this disclosure includes a receiving device and at least one transmitter.

The receiving device of a DSSDDS according to this disclosure may include a directional antenna, a receiver, a processor and one or more indicators. The directional antenna may be configured to be pointed in a plurality of directions, with a strength of a signal of interest diminishing as an angle of orientation of the directional antenna to a source of the signal of interest (e.g., a transmitter) increases (i.e., from 0°, when the directional antenna is pointed directly at the source, to 180°, when the directional antenna is pointed away from the source). The receiver may be configured to receive signals from the directional antenna and to communicate data corresponding to the signals to the processor. The processor may be programmed to process the data (which, for the sake of simplicity, may also be referred to as the “signal of interest”) in a manner that will provide an output to the indicator. The output may enable an individual to accurately determine a direction in which the source of the signal of interest is located.

In some embodiments, the transmitter may be configured to generate a signal of interest that has a predetermined unique temporal pattern, and the processor of the receiving device may be programmed to determine whether or not a detected signal of interest matches, or corresponds to, the predetermined unique temporal pattern and, thus, the processor may recognize the predetermined unique temporal pattern of the signal of interest. To enable a receiving device to be used with and track a plurality of different transmitters, its processor may be programmed to recognize a plurality of different predetermined unique temporal patterns. Without limitation, the predetermined unique temporal pattern may include “on” pulses and “off” periods, with at least two of the “off” periods having unequal durations; a series of “on” pulses spaced by “off” periods comprising short intervals of time; a series of “on” pulses of short duration; a variation in frequency; and a variation in phase. Signals of interest that include variations in frequency and/or phase may be discontinuous signals (i.e., include “on” pulses and “off” periods) or continuous signals (i.e., lack “off” periods). Of course, signals of interest with other types of repeating patterns are also within the scope of this disclosure.

In other embodiments, the signal of interest generated by the transmitter may include “on” pulses and “off” periods. In various embodiments, such a signal may comprise a pattern in which at least two of the “off” periods have unequal durations, a pattern in which at least two of the “on” pulses have different frequencies, a pattern in which at least two of the “on” pulses have different phases, a pattern in which the plurality of “off” periods have the same duration as one another or a pattern in which at least two of the “on” pulses have different durations.

At least some of the “on” pulses and/or “off” periods have a short duration, or comprise a short interval of time. As used in these contexts, the term “short” may include durations of time that are imperceptible to the human ear or that cannot be discerned efficiently by the human ear. For purposes of this disclosure, durations of time that are 30 milliseconds or less are generally considered to be “short.” Alternatively, durations of about 200 milliseconds or less, about 20 milliseconds or less, about 2 milliseconds or less, about 0.2 milliseconds or about 0.02 milliseconds or less may comprise “short” durations of time.

Upon detecting and optionally recognizing a signal of interest, programming of the processor of a receiving device of a DSSDDS according to this disclosure may enable the processor to determine a plurality of received signal strength indicators (RSSIs) for the signal of interest. Each RSSI may correspond to an orientation of the directional antenna relative to the source of the signal of interest or, more specifically, to an angle at which the directional antenna is oriented relative to the source of the signal of interest.

In some embodiments, programming of the processor may also enable consolidation of the signal of interest. More specifically, two or more amplitudes of the signal of interest that correspond to times, frequencies or phases representing the predetermined unique temporal pattern may be consolidated to provide a signal amplitude indicator. Even more specifically, consolidation may comprise pulse RSSI averaging, in which historical points of the signal of interest where the “on” pulses occur are consolidated. Alternatively, consolidation may include deep pattern matching an entire historical signal of interest, including points of the signal of interest where the “on” pulses occur.

In generating the RSSI, programming of the processor may enable the processor to automatically generate a modified RSSI scale. A minimum RSSI of such a scale may be greater than an absolute minimum RSSI possible (e.g., 1 dB above a signal strength that is no longer discernible to the processor, etc.). A maximum RSSI of such a scale may be less than an absolute maximum RSSI (i.e., a signal strength that would occur if the source of the signal of interest were positioned directly adjacent to the tip of the directional antenna), and may correspond to a strongest signal strength expected to be received or that has been received by the antenna and the receiver. A modified RSSI scale may be dynamically adjusted over time (e.g., continuously, periodically, etc.) as a range of RSSIs varies.

Optionally, RSSIs may be used to estimate a distance between the receiving device and a transmitter, or source, of a signal of interest. The use of RSSIs to estimate distance may be accomplished by determining the position of a particular RSSI along a fixed scale of possible RSSIs; e.g., from zero to maximum possible RSSI.

In some embodiments, the processor may be programmed to provide a composite of the RSSI. The composite RSSI may comprise an average of various RSSIs over a set period of time. In some embodiments, the composite RSSI may be based on RSSIs that correspond to signals received by the receiving device over a fraction of a second (e.g., 0.25 second, etc.). In other embodiments, the composite RSSI may be based on RSSIs that correspond to signals received over a period of the past second or more (e.g., six seconds, etc.). As another alternative, the composite RSSI may comprise an average of the RSSIs of signals received over a minute or more (e.g., six minutes, etc.).

The outputs generated by the processor may correspond to the RSSI, and perceptible indicators provided by the indicator of the receiving device may correspond to the RSSI signals, providing an individual with readily discernable indicators of the strength of the signal of interest when the directional antenna is pointed in two or more different directions. In embodiments where the processor of the receiving device of a DSSDDS automatically generates a modified RSSI scale, the output that corresponds to each RSSI may be provided in reference to the minimum RSSI and the maximum RSSI of the modified RSSI scale, as opposed to an absolute RSSI value on a much larger scale of 0 to maximum possible RSSI. In embodiments where the processor of the receiving device calculates a composite RSSI, the indicator may be configured to provide a visual indication of the composite RSSI.

The user-perceptible output of RSSI provided by the indicator of the receiving device may comprise a visual indicator, an audible indicator, a tactile indicator (e.g., vibration, etc.) or any combination of user-perceptible outputs. That user-perceptible output of the indicator may intuitively correspond to the RSSI. Without limitation, the visual indicator may comprise a series of light emitting elements that extend in the same direction as the directional antenna of the receiving device. As another example, the visual indicator may comprise a digital output that corresponds to a relative position (e.g., from 0 to 9, from 0 to 99, etc.) of an RSSI on an RSSI scale (e.g., a modified RSSI scale, etc.). An embodiment of an audible indicator may comprise a tone or a series of tones with a pitch that varies with changes in RSSI (e.g., low-pitched tones correspond to relatively low RSSIs, high-pitched tones correspond to higher RSSIs; a series of tones with larger time spacing corresponding to relatively low RSSIs, shorter time spacing corresponding to higher RSSIs; different sounds corresponding to different RSSIs or to different RSSI ranges; etc.).

A receiving device of a DSSDDS according to this disclosure may also include an orientation element. The orientation element may impart the receiving device with directional awareness, or an ability to determine its orientation (or relative orientation) at any specific point in time. When correlated with RSSI data obtained at specific points in time (e.g., by the processor of the receiving device, etc.), such directional awareness may increase the accuracy and, thus, the efficiency with which an individual may use the receiving device to determine the direction in which the source (e.g., a transmitter, etc.) of a signal of interest is located. In a specific embodiment, the orientation element of a receiving device may comprise a magnetometer.

Of course, the components of a DSSDDS, including transmitters and receiving devices, are also within the scope of this disclosure. A transmitter may be configured to emit a signal that has a predetermined unique temporal pattern and/or a pattern that may not be efficiently perceived, or at all perceptible to the human ear. As disclosed previously herein, a receiving device may be configured to receive signals, determine whether or not the received signals are signals of interest and/or process the signals of interest in a manner that provides outputs (e.g., signal strength outputs, etc.) that may be intuitive to an individual and that an individual may readily discern from one another (e.g., among different signal strengths, etc.).

In another aspect, methods for receiving a signal of interest and for determining a direction in which a source of the signal of interest is located are disclosed. Such a method may include any combination of the functions disclosed previously herein.

Other aspects, as well as features and advantages of various aspects, will become apparent to those of ordinary skill in the art through consideration of the ensuing description, the accompanying drawings and the appended claims.

### BRIEF DESCRIPTION OF THE DRAWINGS

In the drawings:

FIG. 1 depicts an embodiment of a DSSDDS that includes a transmitter and a receiving device with a directional antenna; the receiving device may be used to detect signals from the transmitter and to display the strengths of the signals on one or more output devices in a manner that will enable an individual to determine a direction toward the transmitter or a location of the transmitter;

FIG. 2 shows a manner in which a directional antennal of or associated with a receiving device may be moved between two or more orientations (e.g., along an arcuate path, etc.) to determine the strongest signal strength and, thus, the direction to the transmitter;

FIG. 3 is a block diagram illustrating the main physical sub-systems, various combinations of which may also be referred to herein as a “receiver,” within an interior of the receiving device;

FIG. 4 is a block diagram showing an embodiment of the flow of a radio frequency signal received by the directional antenna and the receiving device through programming, or software modules, executed by a processor of the receiving device, to provide an absolute relative signal strength indicator (RSSI);

FIG. 5 is a block diagram depicting an embodiment of the flow of an absolute RSSI through programming, or software modules, executed by the processor of the receiving device to enable the receiving device to provide various outputs that may be perceived and understood by an individual as he or she uses the receiving device;

FIG. 6 illustrates an embodiment of the manner in which an RSSI scaling function may be performed to simplify or otherwise facilitate an individual's ability to distinguish between the strength of a signal from the transmitter as the directional antenna of the receiving device is pointed in a first direction and the strength of the signal from the transmitter as the directional antenna is pointed in a second direction;

FIGS. 7, 7.3a, 7.3b, and 7.3c show examples of predetermined unique temporal patterns of signals generated by a transmitter of a DSSDDS according to this disclosure;

FIGS. 7.5a-7.5d are graphs illustrating an embodiment of a technique in which amplitudes of “on” pulses of a signal are consolidated;

FIGS. 7.7a-7.7e are graphs depicting an embodiment of a technique referred to as “deep pattern matching” to consolidate a signal; and

FIG. 8 shows an example of a pattern of a signal from a transmitter of an existing DSSDDS.

### DETAILED DESCRIPTION

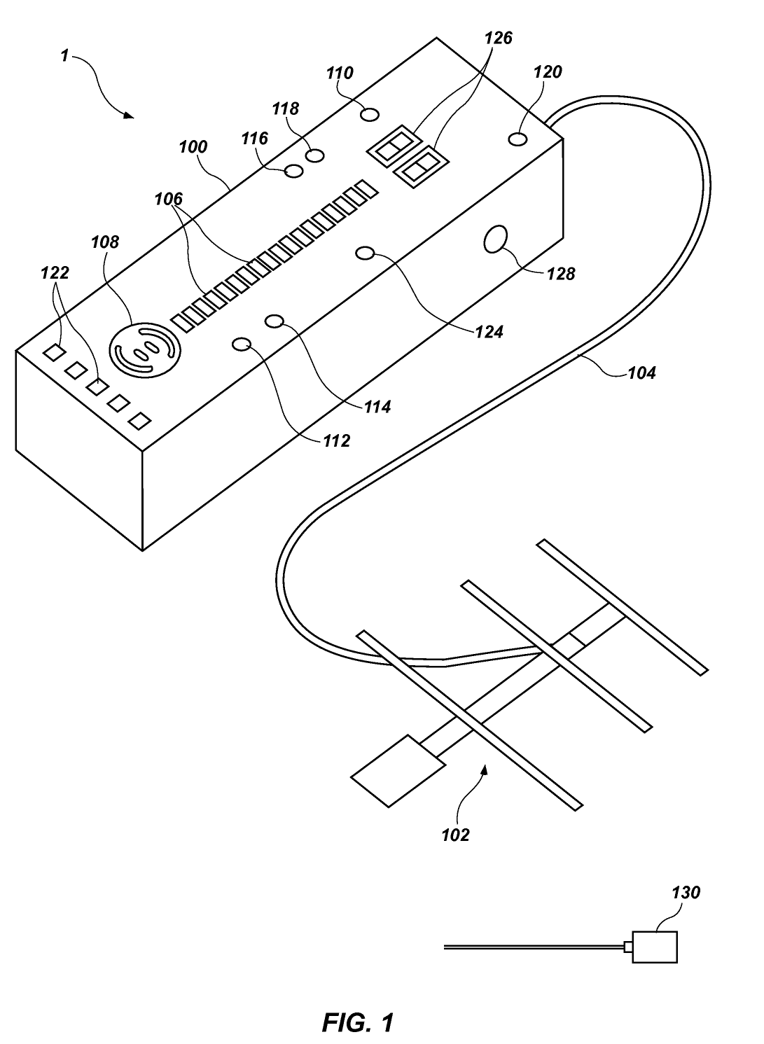

FIG. 1 illustrates an embodiment of a DSSDDS 1, which may include a transmitter 130 and a receiving device 100.

The transmitter 130 of a DSSDDS 1 according to this disclosure may be configured to generate and transmit a signal that may be received by and, in some embodiments, recognized by the receiving device 100. The signal generated and transmitted by the transmitter 130 may lack (e.g., not embody, not convey, etc.) any data. Such a signal may simply be used for tracking the transmitter 130. Alternatively, the transmitter 130 may generate and transmit a signal that conveys information about the transmitter 130 (e.g., information about the estimated life of a power supply of the transmitter 130, etc.). In some embodiments, the transmitter 130 may be configured to transmit signals, but not to receive signals. In other embodiments, the transmitter 130 may also be configured to receive signals and, therefore, may comprise a transceiver.

The embodiment of a receiving device 100 shown in FIG. 1 includes a directional antenna 102 and one or more indicators 106, 108, 122, 126. In addition, the receiving device 100 may include one or more user-interactive components 112, 114, 116, 118, 120, 124, 128, etc., such as buttons or other user-interactive components (e.g., switches, icons on a touch-sensitive display, etc.). The receiving device 100 and the directional antenna 102 may be a hand-held device with a portable power supply (e.g., a battery, etc.).

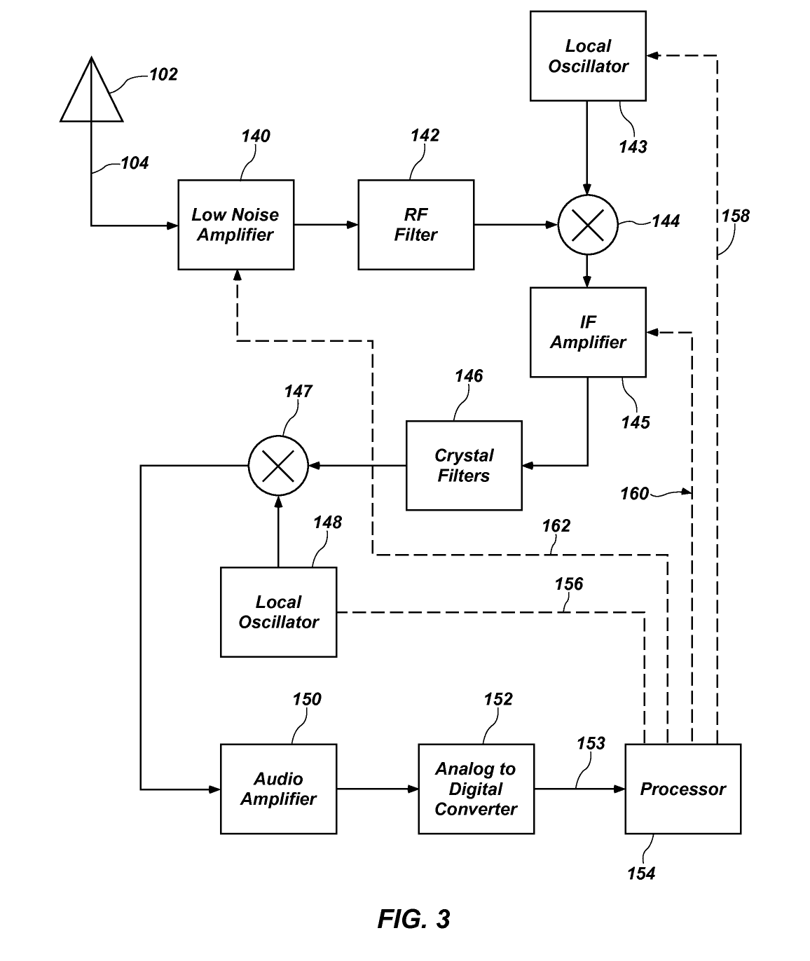

Power to the various components of the receiving device 100 (e.g., each indicator 106, 108, 122, 126; internal components of the receiving device 100 (see, e.g., FIG. 3); etc.) may be turned on and off by any suitable means known in the art. Without limitation, the receiving device 100 may include a power button 120 for this purpose.

The directional antenna 102 of the receiving device 100 may comprise any suitable directional antenna. The directional antenna 102 may comprise an external component of the receiving device 100, a component that is configured to be coupled to (e.g., plugged into, etc.) and uncoupled from (e.g., unplugged from, etc.) a communication port of the receiving device 100 or an internal component within the receiving device 100. In a specific embodiment, a three element yagi may be employed as the directional antenna 102.

The receiving device 100 includes several internal components, shown in FIG. 3, that communicate with (e.g., receive signals from, etc.) the directional antenna 102. In a specific embodiment, a radiofrequency (RF) coaxial cable 104 may establish communication between the directional antenna 102 and the internal components of the receiving device 100.

In general, the receiving device 100 may comprise a narrowband dual conversion receiver with a baseband digital signal processor (DSP) of a type known in the art. For the sake of simplicity, the DSP or any other suitable processing element(s) may be referred to hereinafter as a “processor 154.” The directional antenna 102 and the internal components of the receiving device 100 may be configured to receive signals in the range of 432 MHz to 438 MHz.

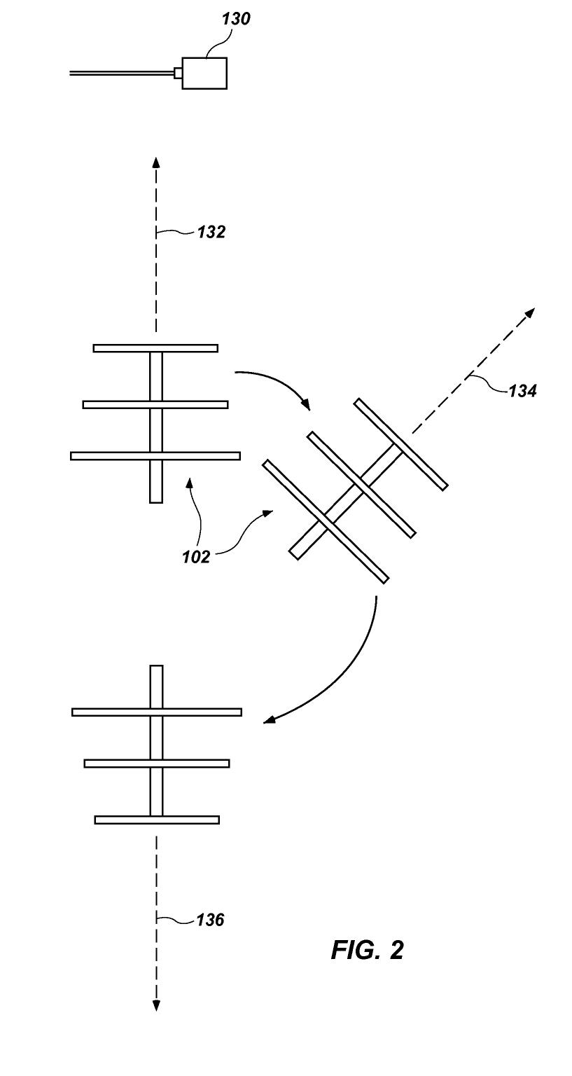

The processor 154 (FIG. 3) of the receiving device 100 may be programmed or otherwise configured to detect a plurality of different unique signals. In such an embodiment, the receiving device 100 may be configured with the ability to select a “channel” that corresponds to a particular unique signal from a plurality of channels that correspond to a plurality of different unique signals. In addition to corresponding to a unique signal, each channel may correspond to a transmitter 130 (FIG. 2) of the DSSDDS 1, with the transmitter 130 being configured to generate and transmit that unique signal. In this regard, one or more user-interactive components 112, 114 of the receiving device 100 may enable an individual to select a particular channel and, thus, a particular transmitter 130 that is to be tracked.

The processor 154 (FIG. 3) may be programmed to process the signal in a manner that improves the speed, the range and/or the accuracy with which the receiving device 100 may be used to determine the direction toward a transmitter 130 (FIG. 2). In general, the processor 154 of the receiving device 100 may be programmed to detect and optionally recognize a signal from a transmitter 130. In addition, programming of the processor 154 may enable the processor 154 to evaluate a strength of the signal when the directional antenna 102 is pointed in a first direction and to compute a relative signal strength indicator (RSSI) that corresponds to the first direction. As the directional antenna 102 is pointed in a plurality of different directions, the processor 154 may compute a plurality of different RSSIs, with each RSSI corresponding to an orientation of the directional antenna 102 relative to the transmitter 130 or, more specifically, to an angle at which the directional antenna 102 is oriented relative to the transmitter 130. Each RSSI provides for an increased ability to distinguish the strength of a signal when the directional antenna 102 is pointed in a first direction from the strength of the signal when the directional antenna 102 is pointed in a different, second direction. Further details on various functions for which the processor 154 may be programmed are provided hereinafter.

The receiving device 100 may include a user-interactive component 128 that enables an individual to cause the receiving device 100 to initiate, or start, a new tracking session. Such a user-interactive component 128 may comprise a button that may be referred to as a “session activation button.” In some embodiments, a session may be initiated by pressing and releasing the user-interactive component 128, and may continue until the user-interactive component 128 is again pressed. In other embodiments, a session may start when the user-interactive component 128 is pressed, and that session will only continue until the user-interactive component 128 is released. When the user-interactive component 128 is used, the receiving device 100 (e.g., its processor 154 (FIG. 3), memory associated with the processor 154, etc.) begins accumulating RSSI values and keeps track of the highest RSSI value that has been computed since the then-current session was initiated. When the highest RSSI value during a particular session is tracked and/or stored, that value may be used to generate and/or adjust (e.g., periodically, dynamically, etc.) any estimated or modified RSSI scale.

Another user-interactive component 124 of the receiving device 100 may enable an individual to select from a plurality of different scaling compression factors that may be used in determining an RSSI scale. Such a user-interactive component 124 may comprise a “scaling compression button.” Selection of a scaling compression factor with the user-interactive component 124 may cause one or more indicators 106, 108, 122, 126 of the receiving device 100 to display RSSI in a more sensitive (e.g., as part of a scale with a smaller range, etc.) or less sensitive (e.g., as part of a scale with a larger range, etc.) manner.

In addition to computing RSSIs and determining RSSI scales, the processor 154 (FIG. 3) is programmed to provide an output of RSSI in a manner that will be readily perceived and understood and/or discerned by an individual. That output may be provided to one or more indicators 106, 108, 122, 126. In some embodiments, one or more of the indicators 106, 108, 122, 126 may be configured in a manner that intuitively corresponds to the RSSI and, thus, that provides an individual with readily discernable indicators of the strength of a signal when the directional antenna 102 is pointed in two or more different directions.

In the embodiment depicted by FIG. 1, indicator 106 comprises a scaled RSSI indicator. The indicator 106 is configured to provide a visual representation of an RSSI of a signal or an average RSSI obtained over a predetermined period of time (e.g., a second or less, about 0.25 second, etc.) along an RSSI scale when the directional antenna 102 is pointed in a particular direction. In the specific embodiment depicted by FIG. 1, the indicator 106 includes a series of light-emitting diodes (LEDs) (e.g., the illustrated indicator includes eighteen (18) LEDs, etc.). The LEDs of such an indicator 106 may be arranged in a manner that corresponds to a direction in which the directional antenna 102 of the receiving device 100 is oriented (e.g., where the directional antenna 102 is secured to an exterior of the receiving device 100; where the directional antenna 102 is located within the receiving device 106; etc.). The LEDs of such an indicator 106 may light up in response to a given RSSI value, such that a weak RSSI causes only the lowest LED to be lit, while successively stronger RSSIs cause additional LEDs to be lit in sequence. Of course, the indicator 106 may be embodied in any of a variety of other ways (e.g., as a liquid crystal display (LCD), as a mechanical indicator, etc.).

In some embodiments, the LEDs of the indicator 106 may be configured to emit light of two or more different colors. Such an embodiment may enable an individual to readily discern between two adjacent LEDs. In addition, under certain conditions (e.g., when the strength of a signal of interest received by the receiving device 100 is relatively weak, etc.), when a series of LEDs of such an indicator 106 are lit, all of the LEDs may emit the same color of light. As an example, when the receiving device 100 receives a weak signal (e.g., a signal having a signal strength that is at the bottom portion (e.g., half, third, etc.) of a scale (e.g., a modified scale, an absolute scale, etc.) of signal strengths), all of the LEDs that are lit may emit yellow light, which may provide an individual using the receiving device 100 with an indication that he or she should move the directional antenna 102 more slowly between two or more orientations in an effort to determine a direction in which the source of the signal (e.g., a transmitter 130, etc.) is located. If the strength of the signal becomes extremely weak, (e.g., a signal having a signal strength that is at the bottom portion (e.g., fourth, fifth, tenth, etc.) of a scale of signal strengths), all of the LEDs that are lit may emit red light, which may provide an individual using the receiving device 100 with an indication that he or she should move the directional antenna 102 even more slowly between two or more orientations. As the signal strength changes, the color of light emitted by the LEDs of the indicator 106 may change to provide an indication of the type of change (i.e., an increase in strength or a decrease in strength).

Another embodiment of an indicator 126 may provide a digital, or numeric, indicator of an RSSI of a signal or an average RSSI obtained from signals that have been received over a predetermined period of time (e.g., more than one second, about 6 seconds, etc.). Such an indicator 126 may comprise one or more digit displays (two are shown in the embodiment depicted by FIG. 1) that provide a digital display and, thus, a visual representation, that corresponds to a relative position (e.g., from 0 to 9, from 0 to 99, etc.) of the RSSI on an RSSI scale (e.g., an estimated or modified RSSI scale, an absolute RSSI scale, etc.). Each digit display of indicator 126 may comprise any suitable type of digit display, such as an LED digit display, an LCD digit display or the like. Such an indicator 126 may display RSSI data in a variety of ways that should be readily apparent to one of ordinary skill in the art.

The receiving device 100 may include an indicator 122 that shows when the receiving device 100 has been powered on and a direction finding session has been actuated. At the beginning of a direction finding session, i.e., at times when the receiving device 100 is actively searching for a signal of interest (e.g., a signal from a transmitter 130 (FIG. 2) of the DSSDDS 1, etc.), the indicator 122 may provide some indication that the receiving device 100 is searching for a signal of interest. Without limitation, a visual display provided by the indicator 122 may repeatedly flash, or turn on and off (e.g., about once per second, etc.) to indicate that the receiving device 100 is actively searching for a signal of interest. Once a signal of interest has been received and confirmed as such, the visual output provided by the indicator 122 may be solid. The indicator 122 may provide a visual representation of an RSSI of a signal or an average RSSI obtained over a predetermined period of time (e.g., 3 seconds or more, a minute or more, etc.). In a specific embodiment, the indicator 122 may include five LEDs, with the number of LEDs that are lit corresponding to the position of a particular RSSI or a particular average RSSI in an RSSI range (e.g., a modified or estimated RSSI range, an absolute RSSI range, etc.). In a specific embodiment, one lit LED of the indicator 122 indicates that the RSSI is in the weakest portion of the RSSI range and five lit LEDs indicates that the RSSI is in the strongest portion of the RSSI range.

Optionally, an indicator 108 of the receiving device 100 may comprise an audio output element, such as a speaker and associated audio components that operate under control of the processor 154 (FIG. 3) of the receiving device 100. Such an indicator 108 may, of course, be configured to provide an output that will be audible to an individual as he or she uses the receiving device 100. Without limitation, the indicator 108 may be configured to output a tone or a series of tones with a pitch, cadence and/or volume that corresponds to the RSSI of a signal received by the directional antenna 102 as it is pointed in a particular direction. The pitch, cadence and/or volume of the tone or series of tones output by the indicator 108 may change as the orientation of the directional antenna 102 changes from a first direction to a different, second direction and, thus, as the strength and the RSSI of signals received by the directional antenna 102 in each orientation change. In a specific embodiment, low-pitched tones may correspond to relatively low RSSIs, high-pitched tones may correspond to higher RSSIs. In another specific embodiment, time spacing between a series of tones may be relatively long for relatively low RSSIs, while shorter time spacing may correspond to higher RSSIs. In other embodiments, different sounds may correspond to different RSSIs and/or RSSI ranges. Of course, the sound output by the indicator 108 may be varied in other ways as the RSSI changes. A volume of the sound(s) output by the audio output element of the indicator 108 may be adjusted by way of one or more buttons 112, 114 of the receiving device 100. In some embodiments, a button 110 of the receiving device 100 may enable an individual to select from a variety of styles of tones and/or tone changes that may be output by the indicator 108.

Turning to FIG. 2, an embodiment of the manner in which the directional antenna 102 of the DSSDDS 1 (FIG. 1) may be oriented in a plurality of different directions to enable an individual to determine a direction toward a signal of interest (e.g., a transmitter 130 of the DSSDDS 1, etc.) is shown. In particular, the directional antenna 102 may be pointed in a plurality of different directions, such as those shown in FIG. 2 as directions 132, 134 and 136. In a specific embodiment, the directional antenna 102 may be moved along an arcuate path. As shown, a strength of a signal of interest diminishes as an angle of orientation of the directional antenna 102 to the source of the signal of interest increases (i.e., from 0°, when the directional antenna 102 is pointed in direction 132 directly at the transmitter 130, to 180°, when the directional antenna 102 is pointed in direction 136 away from the transmitter 130).

As the directional antenna 102 is moved between two or more directions, and receives a signal from each of those directions, the signal is communicated to and processed by components within the receiving device 100, as shown in FIG. 3. In the illustrated embodiment, a signal that has been received by the directional antenna 102 may be communicated from the directional antenna 102 to components within the interior of the receiving device 100 by way of an RF coaxial cable 104. The RF coaxial cable 104 may communicate the signal to a low noise amplifier 140, which may amplify the signal. The signal may then be filtered by an RF filter 142 before being mixed with a signal from a first local oscillator 143 by a mixer 144 to produce a signal at 21.4 MHz. The resulting signal may be further amplified with IF amplifier 145, and then passed through crystal filters 146 before being mixed with a signal from a second local oscillator 148 by another mixer 147 to produce an analog signal at approximately 6 KHz. The 6 KHz analog signal may then be amplified by an audio amplifier 150, and then fed into an analog to digital converter (ADC) 152. The digitized signal 153 produced by the ADC 152 is then communicated to the processor 154. Control lines 156 and 158 respectively enable the processor 154 to control the frequency of the first local oscillator 143 and the second local oscillator 148. Control lines 160 and 162 enable the processor 154 to control the gain of the low noise amplifier 140 and the IF amplifier 145, respectively.

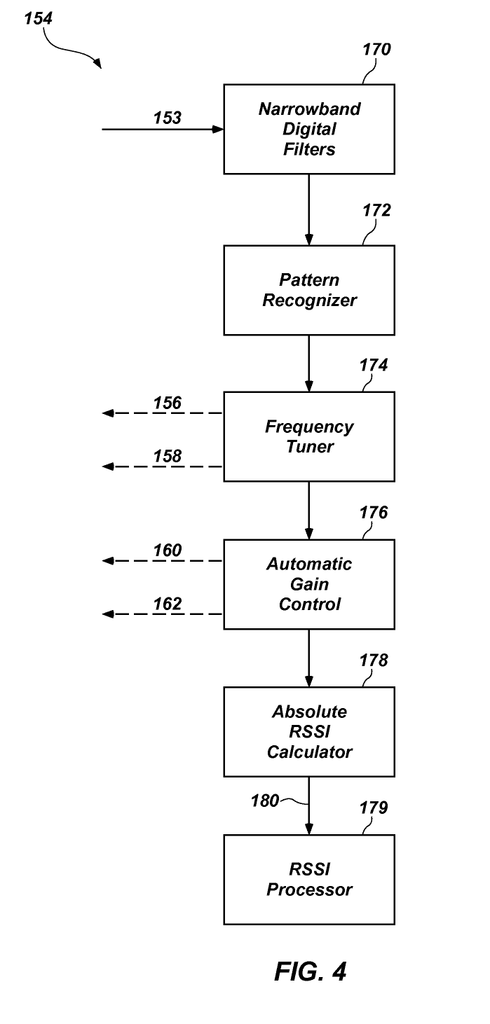

In addition to the above-described components and features, the receiving device 100 may include other amplifiers and various other components, such as one or more power supplies, memory, and connections to LEDs. While none of these additional features is shown in FIG. 1, FIG. 3 or FIG. 4, their functions and the manner in which they may be associated with the processor 154 and other components of the receiving device 100 should be readily apparent to those of ordinary skill in the art.

Turning now to FIG. 4, another block diagram shows an embodiment of the manner in which the digitized signal 153 is processed; for example, by various modules, or programs, executed by the processor 154 of the receiving device 100 (FIG. 3). The digitized signal 153 may be communicated to one or more narrowband digital filters 170, which produce an output in the form of numerical values that represent the strength of the signal at the frequency or frequencies of the signal of interest and which vary in magnitude instantaneously in time. Each narrowband digital filter 170 may discriminate on the basis of frequency or phase, and produce corresponding output.

From the one or more narrowband digital filters 170, the digital signal 153 may be fed into a pattern recognizer 172, which may be configured (e.g., programmed, etc.) to compare a pattern of varying amplitude of the digitized signal 153 with one or more signal patterns (e.g., the same pattern, etc.) that have been preprogrammed into the pattern recognizer 172 and/or into the processor 154 of the receiving device 100 (FIG. 3). When the pattern recognizer 172 determines that the digitized signal 153 corresponds to a preprogrammed signal pattern with a high degree of matching, or certainty, the pattern recognizer 172 confirms that the digitized signal 153 corresponds to a signal of interest, identifies the timing of the incoming signal and, from then on, is able to predict when various elements of the pattern of the digitized signal 153 can be expected. Without limitation, programming of the pattern recognizer 172 may employ a pattern matching algorithm that is configured or adapted for use with the unique nature of the digitized signal 153.

When the presence of a digitized signal 153 has been detected, a frequency tuner 174 detects the frequency or frequencies of the digitized signal 153 relative to the frequency or frequencies of the narrowband digital filters 170 and causes the processor 154 to send feedback signals to the first local oscillator 143 (FIG. 3) along its control line 156 and to the second local oscillator 148 (FIG. 3) along its control line 158 to correct for frequency errors. In addition, an automatic gain control 176 monitors the amplitude of the detected signals and causes the processor 154 to adjust the gain of the low noise amplifier 140 along its control line 160 and of the IF amplifier 145 along its control line 162 to keep the signals within appropriate bounds to avoid overdriving of any of the components of the receiving device 100 (FIG. 3) while enabling high gain to provide for optimal sensitivity when only weak signals are present.

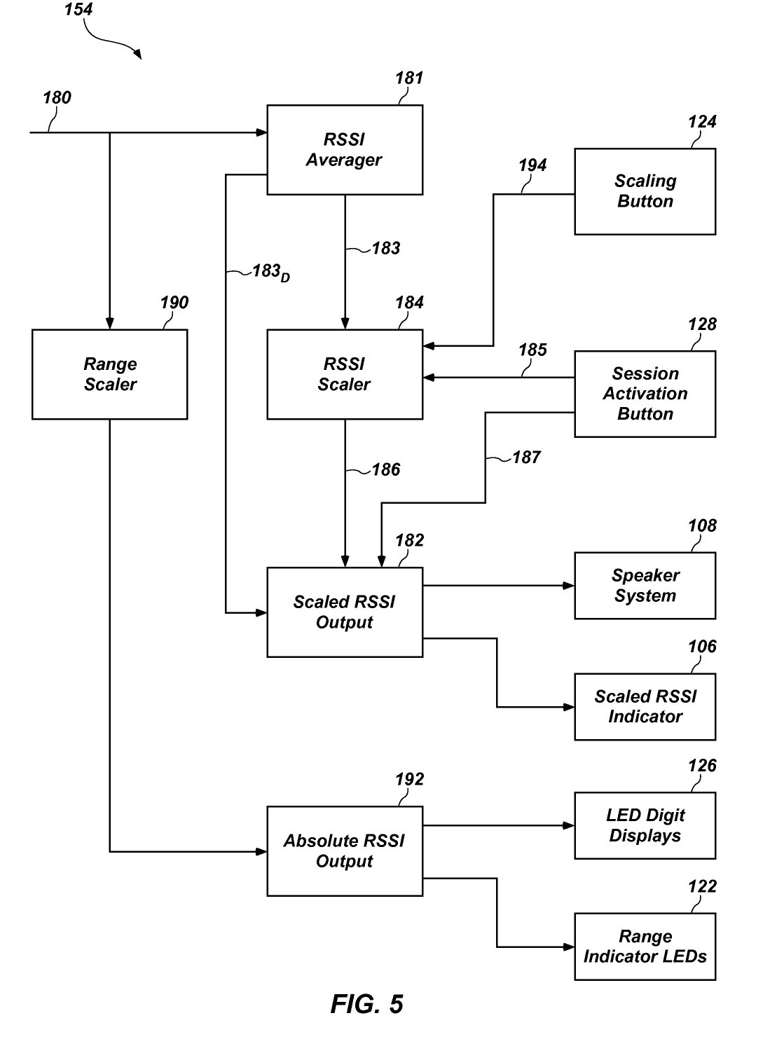

The data from each digital narrowband filter 170, in combination with timing data generated by the pattern recognizer 172, is communicated to an absolute RSSI calculator 178, which determines an absolute RSSI 180 of each element, or portion, of the digitized signal 153 as that element is received by the processor 154. The absolute RSSI calculator 178 also receives information from the automatic gain control 176 as to the gain settings, and adjusts the absolute RSSI 180 up or down to compensate for the varying levels of gain. The absolute RSSI 180 may then be communicated to the RSSI processor 179, details of which are described in reference to FIG. 5.

The processor 154 may be programmed to provide a composite of the RSSI, which may effectively consolidate a plurality of portions, or segments, of a signal received at different points in time, which may be referred to as “time segments” of the signal, or a plurality of signals received at different points in time, with one another. In some embodiments, the RSSI composite may comprise an average of various RSSIs over a set period of time. In some embodiments, the composite RSSI may be based on RSSIs that correspond to signals received by the receiving device 100 over a fraction of a second (e.g., 0.25 second, etc.). In other embodiments, the composite RSSI may be based on RSSIs that correspond to signals received over a period of the past second or more (e.g., six seconds, etc.). As another alternative, the composite RSSI may comprise an average of the RSSIs of signals received over a minute or more (e.g., six minutes, etc.). In embodiments where the processor 154 of the receiving device 100 calculates a composite RSSI, the indicator may be configured to provide a visual or aural indication of the composite RSSI.

With reference to FIG. 5, a specific, but non-limiting embodiment of such an averaging process is depicted. The absolute RSSI 180 may be communicated to an RSSI averager 181 which computes an average relative strength, or an average RSSI 183, of an incoming signal. Based on the average RSSI 183, the RSSI averager 181 may determine an appropriate length of time over which to average absolute RSSIs 180. In the case of a very weak signal, or a signal with very weak time segments, an average RSSI 183 that is based on absolute RSSIs 180 computed over a longer period of time may be presented to the user. This may reduce variation in the instantaneous values of the absolute RSSI 180 that occur naturally through the effects of noise entering the system along with the signals and, thereby, prevents the user from being confused by these variations while pointing the directional antenna 102 (FIGS. 1-3) in a plurality of different directions and observing the output on an indicator 106, 108, 122. Data 183_{D} regarding a degree to which the RSSI has been averaged may be communicated to a scaled RSSI output process 182 in order to alert an individual using the receiving device 100 (FIGS. 1 and 3) to the need to move (e.g., rotate, etc.) the directional antenna 102 more slowly to compensate for the averaging that is taking place when the signal or a time segment thereof is weak.

With continued reference to FIG. 5, in embodiments where the processor 154 of the receiving device 100 (FIGS. 1-3) of a DSSDDS 1 (FIG. 1) automatically generates a modified RSSI scale, the output that corresponds to each absolute RSSI 180 may be provided in reference to a minimum RSSI and a maximum RSSI of the modified RSSI scale, as opposed to the location of the absolute RSSI 180 on a much larger scale of 0 to the maximum possible RSSI. The minimum RSSI of such a modified RSSI scale may be greater than an absolute minimum RSSI possible (e.g., 1 dB above a signal strength that is no longer discernible to the processor, etc.). A maximum RSSI of such a modified RSSI scale may be less than an absolute maximum RSSI (i.e., a signal strength that would occur if the source of the signal of interest were positioned directly adjacent to the tip of the directional antenna 102 (FIGS. 2 and 3)), and may correspond to a strongest signal strength expected to be received or that has been received by the directional antenna 102 and the receiving device 100 for a certain period of operation of the receiving device 100. A modified RSSI scale may be dynamically adjusted over time (e.g., continuously, periodically, etc.) as a range of absolute RSSIs 180 varies.

The average RSSI 183 from the RSSI averager 181 may be communicated to an RSSI scaler 184. As indicated previously herein, the session may be initiated when the receiving device 100 (FIG. 1) is turned on, or powered up, when an individual initiates a new session (e.g., by interacting with a user-interactive component 128, such as a button; etc.) or in any other suitable manner. When a new session is initiated by an individual, the initiation of a new session 185 may be communicated from the user-interactive component 128 to the RSSI scaler 184 module of the processor 154. The RSSI scaler 184 may calculate a modified RSSI scale. The maximum RSSI for the modified RSSI scale may be the maximum absolute RSSI 180 that has been computed since the beginning of the then-current session. The minimum RSSI of the modified RSSI scale for a session may also comprise an absolute RSSI value.

In addition, the RSSI scaler 184 may calculate a scaled RSSI 186 for every instantaneous absolute RSSI 180 as a function of the instantaneous absolute RSSI 180 and the maximum RSSI for the modified RSSI scale generated during the then-current session. Alternatively, or in addition to calculating scaled RSSIs 186 that correspond to each absolute RSSI 180, the RSSI scaler 184 may calculate a scaled RSSI 186 for each composite, or consolidated, RSSI.

The scaled RSSI 186 may have a value from zero to 100%. The zero value of the scaled RSSI 186 may be assigned when the absolute RSSI 180 has a value equal to or less than a minimum RSSI for the modified scale. A scaled RSSI 186 with a 0% value is indicative of a negligible signal coming from the direction in which the directional antenna 102 (FIGS. 1-3) is oriented relative to the maximum RSSI for the session, even though, in absolute terms, the signal might actually be strong. A scaled RSSI 186 with a 100% value may indicate that the absolute RSSI 180 is equal to the maximum RSSI for the modified RSSI scale. If the absolute RSSI 180 exceeds the maximum RSSI, the RSSI scaler 184 may adjust the modified RSSI scale (e.g., by assigning a new, higher maximum RSSI, etc.).

In embodiments where the receiving device 100 (FIG. 1) includes a user-interactive component 124 that provides for scaling compression, an individual using the receiving device 100 may use the user-interactive component 124 to select a scaling compression factor (SCF) that specifies a minimum RSSI 194 that is used define a modified RSSI scale and that may be used to provide a scaled RSSI 186. Expansion of a modified RSSI scale in this manner may decrease the sensitivity with which one scaled RSSI 186 may be distinguished from another scaled RSSI 186, while contraction of a modified RSSI scale in this manner may increase a sensitivity with which one scaled RSSI 186 may be distinguished from another scaled RSSI 186. In a specific embodiment, the RSSI scaler 184 may employ the following formulas to cases where the instantaneous absolute RSSI 180 is greater than the minimum absolute RSSI:

RSSIₘᵢₙ=RSSI_{max session}×SCF; (1)

RSSI_{scaled}=(RSSI_{absolute}−RSSIₘᵢₙ)(RSSI_{max session}×(1−SCF))×100%. (2)

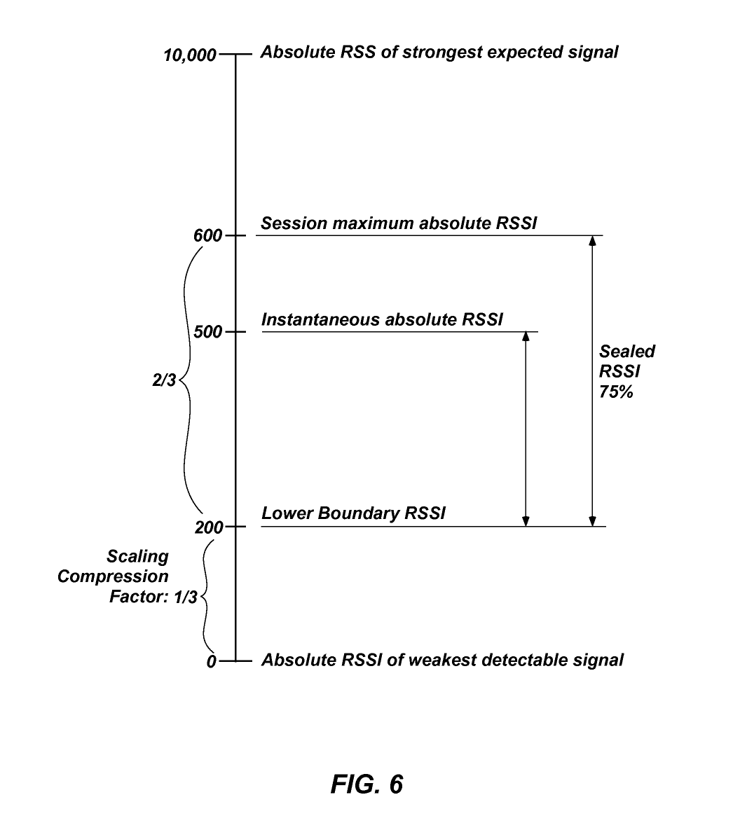

FIG. 6 shows an embodiment of a modified RSSI scale, and provides an example of the calculation of a scaled RSSI 186 based on the minimum RSSI 194 of the modified RSSI scale, the maximum RSSI of the modified RSSI scale and an absolute RSSI 180. For a session in which the maximum absolute RSSI 180 has a value of 600 and an SCF of ⅓ is used, equation (1) may be used to determine the minimum RSSI 194 (RSSIₘᵢₙ) of the modified RSSI scale. The minimum RSSI 194 may have a value of 200. Those values may then be used in equation (2), along with an instantaneous absolute RSSI 180 (RSSI_{absolute}), which is 500, to calculate, or compute, a scaled RSSI 186 (RSSI_{scaled}), which is 75%. Of course, this embodiment should not be considered to limit the scope of the manner in which a scaled RSSI 186 may be calculated, as a variety of other techniques and/or algorithms may also be used.

With returned reference to FIG. 5, the processor 154 may output the scaled RSSI 186. The scaled RSSI 186 may be communicated to one or more indicators 106, 108, 122, 126 in a suitable manner.

With added reference to FIG. 1, while a session remains active, the processor 154 may cause the indicator 106 to provide a user-perceptible output that corresponds to the scaled RSSI 186. More specifically, based on the modified RSSI scale and the scaled RSSI 186 at a particular point in time, the processor 154 may cause the indicator 106 to provide a visual representation of the scaled RSSI 186 relative to the modified scale. Even more specifically, in embodiments where the indicator 106 comprises a series of LEDs, the processor 154 may cause a lower most LED of the indicator 106 and a sequence of immediately adjacent LEDs of the indicator 106 to light up.

Optionally, during an active session, the processor 154 may cause an indicator 108 that comprises an audio output element to emit a series of tones; for example, in a manner such as those described previously herein.

In some embodiments, an absolute RSSI 180 and/or a scaled RSSI 186 may be used to estimate a distance, or a range, between the receiving device 100 (FIG. 1) and a source of a signal of interest (e.g., a transmitter 130 (FIG. 1), etc.). The use of RSSIs to estimate distance may be accomplished by determining the position of a particular RSSI along a fixed scale of possible RSSIs; e.g., from zero to maximum possible RSSI. An estimate of the distance between the receiving device 100 and the transmitter 130 or another source of a signal of interest may be accomplished by a range scaler 190 of the processor 154. An absolute RSSI 180 may be received by the range scaler 190, which may convert the absolute RSSI 180 into a format that can be displayed; for example, by indicator 122 and/or by indicator 126. More specifically, the range scaler 190 may convert the absolute RSSI 180 to a value on an absolute scale, such as a scale from 0 to 99, where 0 is indicative of the weakest signal strength that can be discerned by the receiving device 100 and 99 indicates the strongest signal strength the receiving device 100 can be expected to receive, which may be calibrated in advance to be a signal strength that is approximately that of a signal generated and transmitted by a transmitter 130 positioned within a short distance (e.g., 1 m, etc.) of the directional antenna 102 (FIGS. 1-3). In order to accommodate the vast difference in magnitude between these extremes, the actual value generated by the range scaler 190 may be a logarithm of the absolute RSSI 180. A logarithm of range-scaled absolute RSSI 180 may be subtracted from the logarithm of an estimated maximum RSSI corresponding to that obtained when the transmitter is in immediate proximity to the directional antenna 102, so as to invert the signal strength and cause it to represent an estimate of the actual distance to the transmitter, as opposed to merely a signal strength. The resulting number may be normalized in terms of distance in any kind of units to represent an estimate of a distance from the receiving device 100 to the transmitter 130 or other signal source.

Once an absolute RSSI 180 has been subjected to range scaling, an absolute RSSI output module 192 of the processor 154 may provide a visual indicator of the distance between the receiving device 100 (FIG. 1) and the transmitter 130 (FIG. 1) or another source of a signal of interest. Without limitation, the range-scaled RSSI may be output to a digital indicator 126, which may provide a value that corresponds to an estimated distance between the receiving device 100 and the transmitter 130. Alternatively, a meter-type indicator 122 may provide a visual representation, but not a corresponding value, of a distance between the receiving device 100 and the transmitter 130. For example, when the range-scaled RSSI indicates that the transmitter 130 is close to the receiving device 100, all of the LEDs of the depicted embodiment of indicator 122 may light up, whereas fewer LEDs will be lit as the distance between the receiving device 100 and the transmitter 130 becomes increasingly larger.

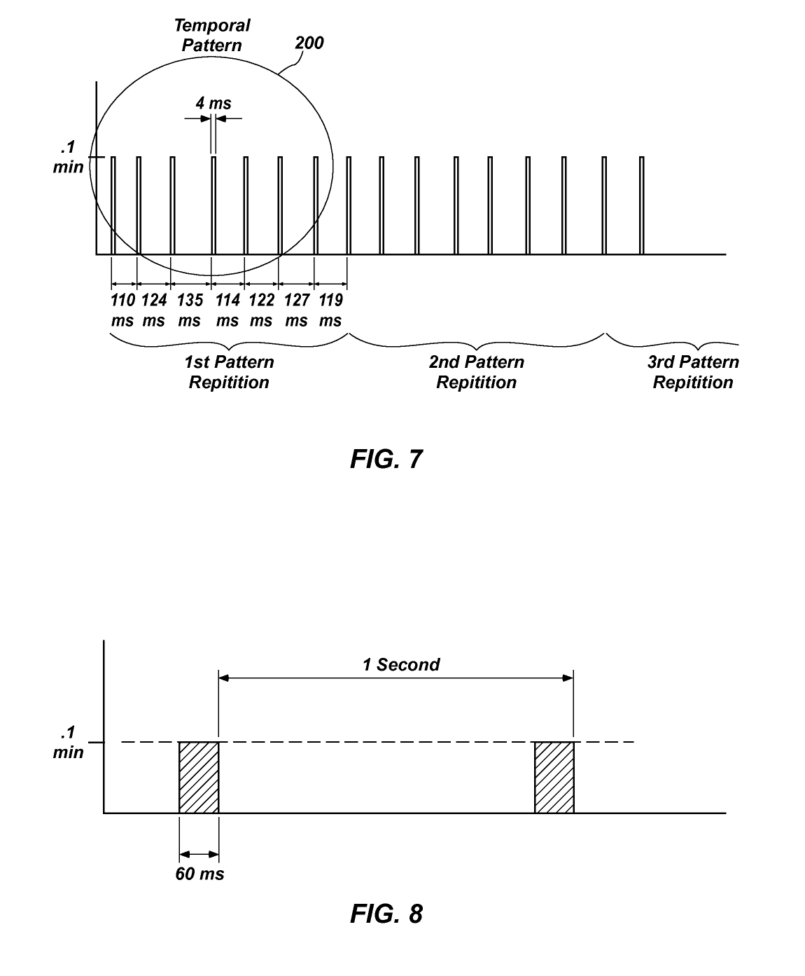

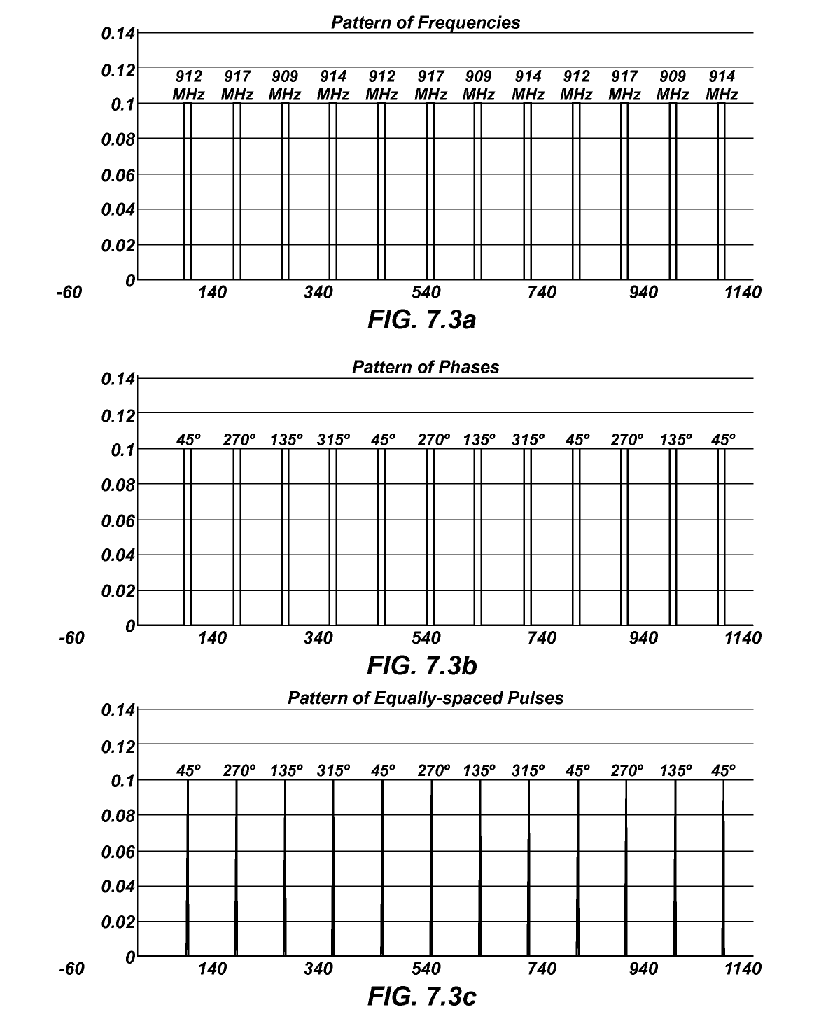

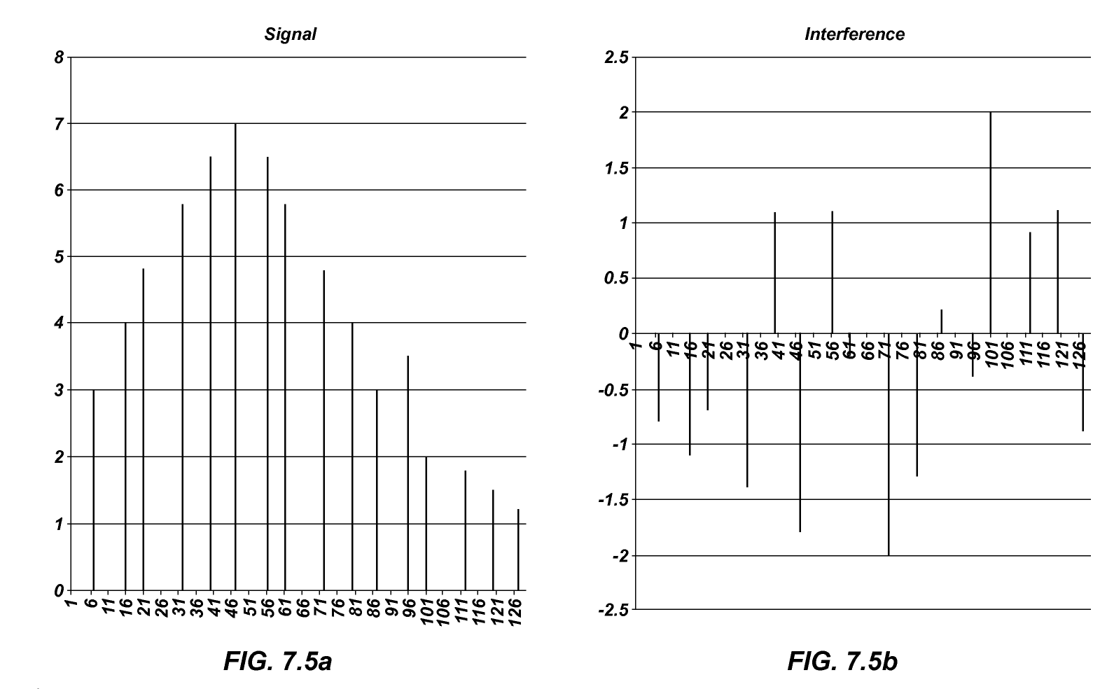

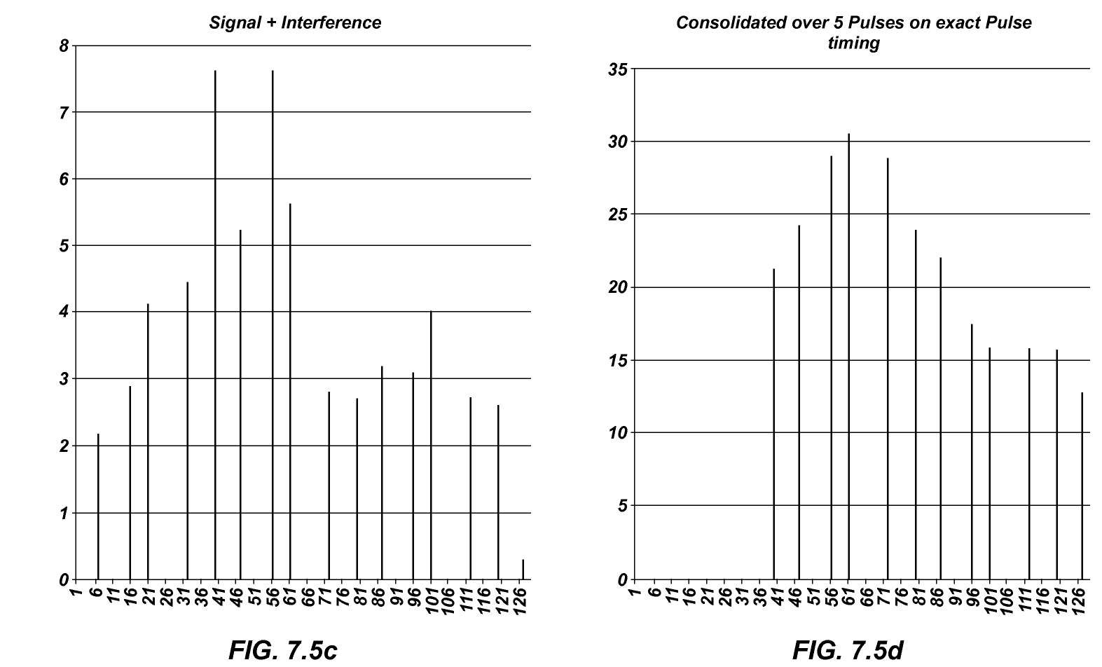

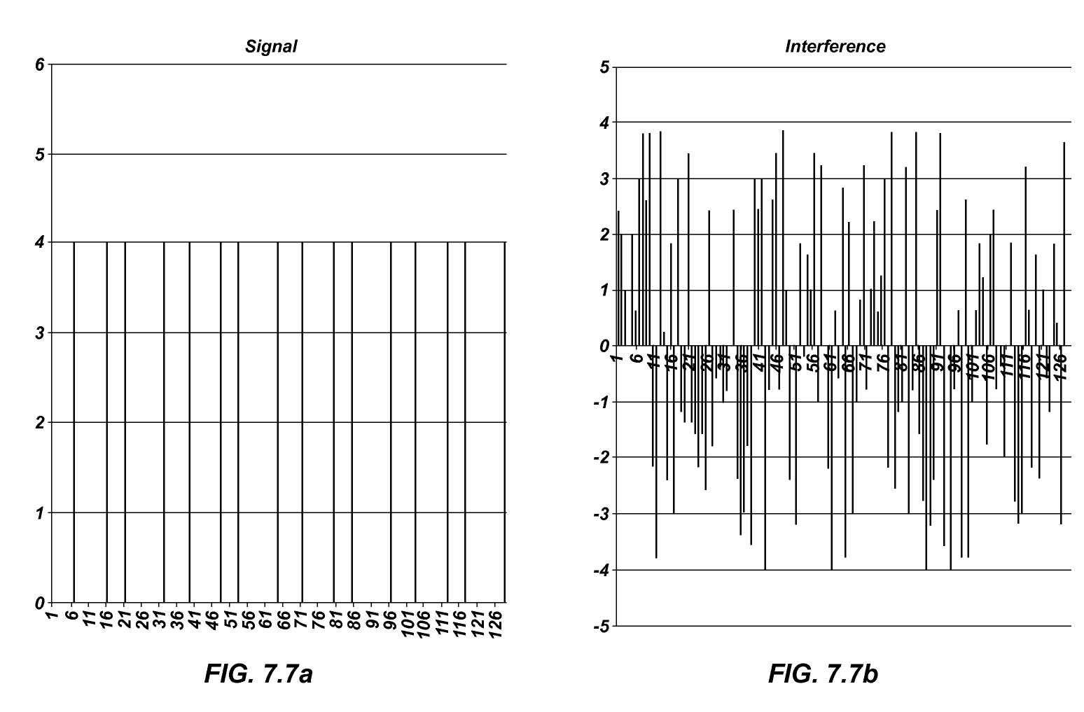

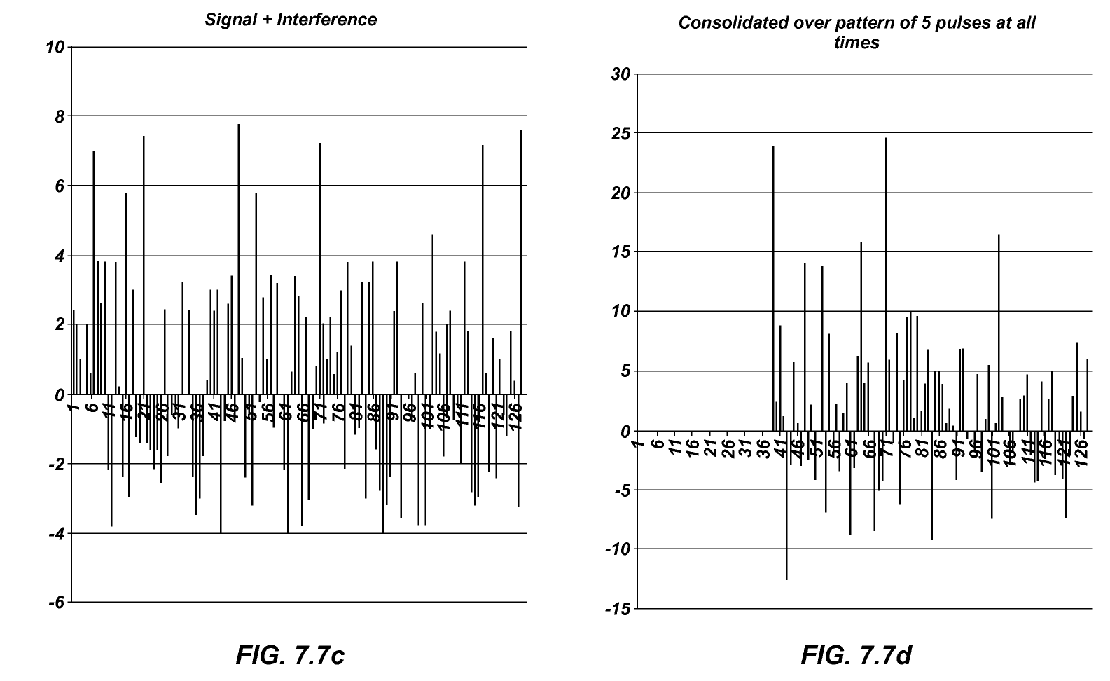

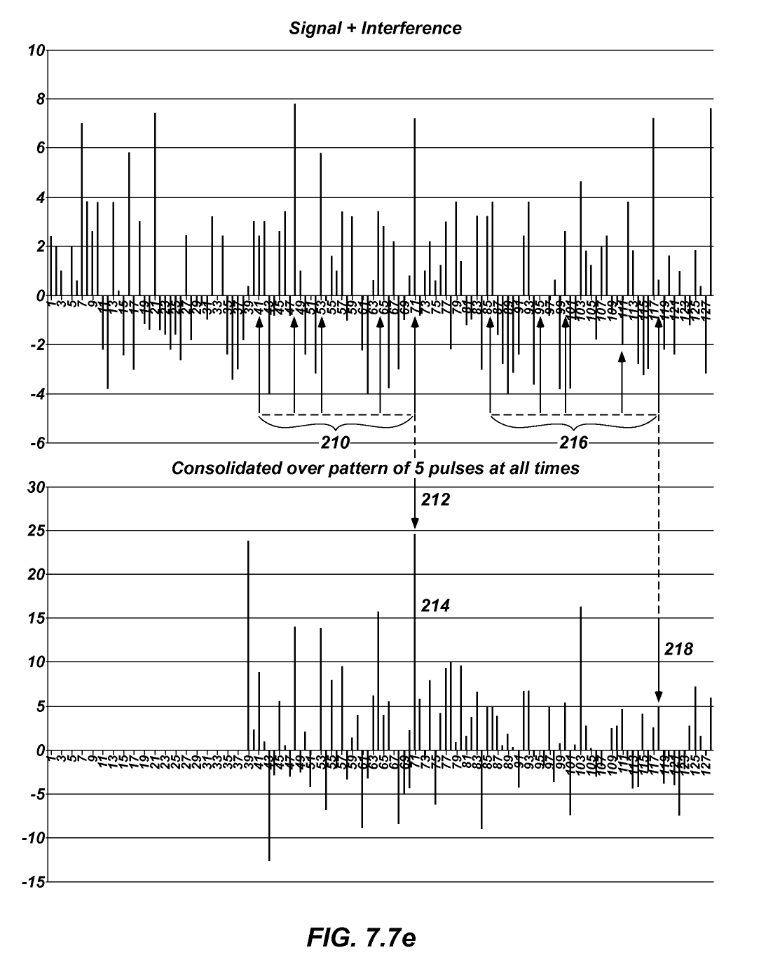

Now turning to FIG. 7, in some embodiments, the transmitter 130 (FIG. 1) of a DSSDDS 1 (FIG. 1) may be configured to generate a signal of interest that has a predetermined unique temporal pattern, and the processor 154 (FIG. 3) of the receiving device 100 (FIG. 1) may be programmed to determine whether or not a detected signal of interest matches, or corresponds to, the predetermined unique temporal pattern. Thus, the processor 154 may recognize the predetermined unique temporal pattern of the signal of interest. To enable a receiving device 100 to be used with and to track a plurality of different transmitters 130, its processor 154 may be programmed to recognize a plurality of different predetermined unique temporal patterns.

Without limitation, the predetermined unique temporal pattern may include “on” pulses and “off” periods, with at least two of the “off” periods having unequal durations; a series of “on” pulses spaced by “off” periods comprising short intervals of time; a series of “on” pulses of short duration; a variation in frequency; and a variation in phase. Signals of interest that include variations in frequency and/or phase may be discontinuous signals (i.e., include “on” pulses and “off” periods) or continuous signals (i.e., lack “off” periods).

In other embodiments, the signal of interest generated by the transmitter may include “on” pulses and “off” periods, with at least some of the “on” pulses and/or “off” periods having a short duration, or comprising a short interval of time. As used in these contexts, the term “short” may include durations of time that are imperceptible to the human ear or that cannot be discerned efficiently by the human ear. For purposes of this disclosure, durations of time that are 30 milliseconds or less are generally considered to be “short.” Alternatively, durations of about 200 milliseconds or less, about 20 milliseconds or less, about 2 milliseconds or less, about 0.2 milliseconds or about 0.02 milliseconds or less may comprise “short” durations of time.

FIG. 7 shows a specific embodiment of a predetermined unique temporal pattern that may be produced by a transmitter 130 (FIG. 1) of a DSSDDS 1 (FIG. 1). The transmitter 130 is configured to emit a series of continuous wave (CW) pulses of a single, constant amplitude and of a single, constant frequency (e.g., an amplitude of 0.1 mW, a frequency of 433.535 MHz, etc.). The pulses of the illustrated waveform are all 4 ms in duration and spaced apart in time by different intervals ranging from 100 ms to 140 ms. In the specific embodiment illustrated by FIG. 7, the pattern of pulses may repeat every 0.851 seconds. Thus, pulses of such a waveform are received by the directional antenna 102 and, thus, by the receiving device 100 (FIG. 1) rapidly enough that, as the direction in which the directional antenna 102 changes, changes in the amplitudes of the pulses appear almost immediately on the scaled visible output provided by indicator 106 of the receiving device 100 and in the tone produced by the audio output element of indicator 108 of the receiving device 100. Such a rapid response makes the direction finding process faster, more accurate, and more pleasant for an individual to perform.

By way of contrast, the pulses produced by transmitters of existing DSSDDSs must be relatively long in order to be detected aurally by the user; for example, they might typically be 33 ms long or longer and spaced at intervals of 1 second or more, as shown in FIG. 8. Notably, the signals illustrated by FIGS. 7 and 8 have the same duty cycles (i.e., 3.29%) and, thus, consume power from the power supply (e.g., battery, etc.) of the transmitter 130 (FIG. 1) at the same rate. However, since the durations of the pulses and spacing between pulses of such a signal are so long, the receiving device 100 receives fewer pulses of such a signal over time. Consequently, the receiving device 100 cannot determine changes in the strength of the signal as readily; thus, subtle changes in the strength of the signal as the orientation of the directional antenna 102 changes may not discerned by an individual as he or she uses the receiving device 100. Therefore, the receiving device 100 may slowly, and only intermittently, respond to changes in antenna direction. As a result, use of a signal of the type depicted by FIG. 8 results in a much slower, less accurate direction finding process.

FIG. 7.3a shows another example of a predetermined unique temporal pattern that may be produced by a transmitter 130. In this embodiment, the emitted signal from the transmitter 130 is a series of CW pulses of a single, constant amplitude. Each of the CW pulses is 16 ms in duration, and the CW pulses are spaced apart from one another in equal durations so the pattern repeats every 128 ms. The frequency of each pulse may vary in order to produce a predetermined unique temporal pattern. In the illustrated embodiment, the predetermined unique temporal pattern of pulse frequencies repeats in time after every 4 pulses or, in this particular embodiment, after 512 ms. This scheme may be desirable when the allowed spectrum permits it.

FIG. 7.3b shows another embodiment of signal, which is like that shown in FIG. 7.3a, except in this case, the pulses are all of the same frequency, but vary in phase to produce the predetermined unique temporal pattern. This scheme may be desirable when the spectrum available does not permit varying frequencies and when very stable frequencies can be achieved so as to minimize the drift in phase between pulses. In particular, this scheme may be desirable when neither the transmitter 130 nor the receiving device 100 is moving rapidly enough to produce significant Doppler shifting of the frequency that will introduce random deviations into the phase of pulses detected by the receiver.

FIG. 7.3c shows another example like that of FIG. 7.3a, except in this case, the pulses are all of the same frequency and of the same phase, or of indeterminate phase. The predetermined unique temporal pattern is merely a set of a certain predetermined number of such pulses, for example, a set of 4 pulses. Even though it may appear that this predetermined unique temporal pattern is the same as a trivial pattern of one pulse, the predetermined unique temporal pattern is significant for the purposes of consolidating pulses described below. The predetermined unique temporal pattern of amplitudes in the signal of interest has been restored closer to its true form through the consolidation process, resulting in an improved presentation of the signal strength information to an individual using the receiving device 100 (FIG. 1).

One benefit of the use of predetermined unique temporal patterns in the context of this disclosure is that it permits the consolidation of information from the individual pulses of energy from the transmitter 100 (FIG. 1). Once the predetermined unique temporal pattern is recognized by the receiver, the exact timing of pulses may be known, which permits energy from individual pulses to be consolidated. This is especially beneficial in situations when the signal of interest may be significantly contaminated with interference from other radio sources, including other transmitters, or other kinds of noise. This is especially likely to be the case when the signal of interest is relatively weak because the transmitter 130 (FIG. 1), is far away or impeded by obstacles on its path of propagation. One problem is that this contamination may cause the RSSI determined from the signal of interest to vary randomly in such a way as to confuse the user of the system. Another problem is that weak signals may be difficult to detect in the first place.

Existing devices are typically not configured to focus on such weak signal situations and, therefore, no one has taught or suggested that consolidation of the signal of interest over time, especially over long periods of time of, say, more than one second, may be beneficial or would even be possible. In particular, the hardware that has been used in the art for detection of signals by the human ear does not have the capacity to evolve or be adapted to do such consolidation, which requires a wholly different and new architecture and processing capacity than is available in existing DSSDDSs. For example, at a minimum, a digital processor is required, and the few existing DSSDDSs that do have digital signal processors still lack the deep memory and the high speed processing bandwidth necessary to perform the computation that is required to consolidate data over time effectively. In one embodiment, a receiving device 100 includes a dedicated DSP processor running at 400 MHz with extended external memory of 512 megabits, which is vastly more powerful than the processors of the receiving devices of any existing DSSDDS. Likewise, DSSDDSs that use industry standard hardware, software, or protocols such as IEEE wireless protocols cannot be easily adapted to implement signal consolidation.

FIGS. 7.5a-7.5d show an embodiment of consolidation of the amplitudes of the “on” pulses of a signal, which may be referred to as “pulse RSSI averaging.” FIG. 7.5a shows an embodiment of the signal of interest, which consists of a series of five pulses having a predetermined unique temporal pattern of unequal spacings, or “off” periods, between “on” pulses. Even though the pulses are shown as lines in the drawing, it should be understood that the lines represent pulses of RF energy from the transmitter 130 (FIG. 1) of a finite period of time, for example, 4 ms, which are interspersed with the “off” periods. The signal of interest is depicted as rising and then falling in a manner that would be typical of the situation in which the user is sweeping the directional antenna 102 (FIG. 1) past the direction to the transmitter 130 (FIG. 1). FIG. 7.5b shows an example of interference, which is unavoidably present along with the signal, in the digitized signal 153 (FIG. 3), which, when added to the signal of interest, produces the result seen in FIG. 7.5c. For simplicity, the only interference shown is that which coincides with the actual “on” pulses of the signal of interest, but it should be understood that the interference will be present during the “off” periods as well. The presence of the signal of interest shown in FIG. 7.5c is partially obscured by the contaminating interference and is highly variable, producing a distorted pattern. This represents the instantaneous absolute RSSI 180 (FIG. 4) values which are presented to the RSSI averager 181 (FIG. 4). FIG. 7.5d shows the result of a simple average of the most recent five absolute RSSI 180 values corresponding to the times of the most recent five “on” pulses. In FIG. 7.5d, the absence of any output during the initial time period on the left is due to the fact that this kind of consolidation over time requires a start-up period during which a sufficient history of data is built up in order for the consolidation algorithm to be able to look back when consolidating previous data of the stream of data. The pattern of amplitudes in the signal of interest has been restored closer to its true form through this process, resulting in the presentation of an improved output to an individual using the receiving device.

In FIG. 7.5d, it will be noted that this pulse RSSI averaging variety of pulse consolidation has delayed in time the pattern of amplitudes of the signal of interest, an undesirable effect which may cause the user to misjudge the true direction to the transmitter 130 (FIG. 1). In order to mitigate this delay, the receiving device 100 (FIG. 1) may provide an individual with an indication suggesting that the individual slow down the process of moving the orientation of (e.g., sweeping, rotating, etc.) the directional antenna 102 (FIG. 1) from one direction to another. In one embodiment, this indication may include changing the color of the lights on the indicator 106 (FIG. 1) that displays a scaled RSSI 186 to a certain color, such as red or yellow. The processor 154 (FIG. 3) may change the degree of consolidation or altogether eliminate consolidation over the course of usage of the receiving device 100, depending on the changing conditions of interference and signal strength.

Pulse RSSI averaging consolidation, as depicted by FIGS. 7.5a-7.5d, which is useful for reducing variability of the RSSI that is presented to an individual for use in determining a direction from which a signal of interest originates by moving a directional antenna 102 (FIG. 1) may be accomplished over a time scale that corresponds to, or is of the same order as, the time scale of the expected movement of the directional antenna 102. Typically, such a time scale may last from a few tenths of a second to several seconds. Variations in RSSI may occur more rapidly than the time scales associated with movement of the directional antenna 102; for example, on the order of milliseconds or microseconds, and variations in RSSI may be reduced by incidental averaging or other techniques, but these internal machinations are distinct from and irrelevant to the purposeful and longer term consolidation of the RSSI data, which may be presented to an individual on the order of the timescale on which he or she operates.

Consolidation of a signal of interest is unique and non-obvious because it requires special algorithms and a processor with deep memory, which are absent from existing DSSDDSs. Furthermore, dealing with the lag time in exchange for the benefits of consolidation wouldn't have been obvious to one of ordinary skill in the art.

It will be appreciated that besides pulse RSSI averaging, many other kinds of consolidation or averaging may also be used. The word “averaging,” as used herein, may refer to all kinds of integration or arithmetic consolidation of a set of values. In place of averaging, it may be desirable to integrate the signal amplitudes. It may be desirable for a pulse RSSI averaging process of consolidation to extend over a relatively long period of time and over many “on” pulses. As a non-limiting example, the depth of consolidation may extend over a period of 25 “on” pulses rather a period of five “on” pulses, and may cover a period of time of 10 seconds. The considerable delays introduced by such long consolidations may be a worthwhile tradeoff for the benefit of increased accuracy and the ability to locate the direction to further away transmitters.

Consolidation of information corresponding to a multiplicity of “on” pulses can be done in many other ways and can be additionally implemented in many other processes within the receiving device 100 (FIG. 1).

A further embodiment of consolidation may include “deep pattern matching,” which refers to a consolidation process that the processor 154 (FIG. 3) may utilize as it undertakes discovering and continually recognizing the presence and timing of the predetermined unique temporal pattern in the digitized signal 153 (FIG. 3), and subsequently, to maintain that recognition and timing. These processes may be referred to herein, for simplicity, as “locking onto” the signal of interest and staying “locked onto” the signal of interest. Deep pattern matching is beneficial in locking on because the presence of interference, among other things, may disguise the presence of “on” pulses and prevent the processor from recognizing individual “on” pulses as well as patterns of “on” pulses, thus reducing the range over which the transmitter 130 (FIG. 1) can be located and environments in which it can be used.

FIGS. 7.7a-7.7e show an embodiment of deep pattern matching. Deep pattern matching may be incorporated within the pattern recognizer 172 (FIG. 4) to enhance its ability to lock onto the signal of interest. FIG. 7.7a shows an embodiment of the signal of interest, which consists of a series of “on” pulses having a unique temporal pattern of unequal spacings, or “off” periods, between the “on” pulses. For simplicity, the “on” pulses in this example are all of equal amplitude. FIG. 7.7b shows an example of interference, which is unavoidably present, along with the signal of interest in the digitized signal 153 (FIG. 3). When added to the signal of interest, the interference produces the result seen in FIG. 7.7c. In contrast to FIG. 7.5b, the interference between the “on” pulses is shown, and in contrast to FIG. 7.7b, in FIG. 7.7c the complete stream of data in the digitized signal 153 (FIG. 3) is shown. In such a situation the pattern itself is disguised by the interference. In order to enable the pattern recognizer 172 (FIG. 4) to detect the predetermined unique temporal pattern in this situation, one repetition of the predetermined unique temporal pattern is consolidated over a period of time to all points equally in the complete stream of data in the digitized signal 153 (FIG. 3). In FIG. 7.7d, the absence of any output during the initial time period on the left is due to the fact that this kind of consolidation over time requires a start-up period to build up a history of data. The effect of deep pattern matching is to produce an output in which an enhanced signal representing the signal of interest is produced when the pattern being applied exactly lines up with the unknown pattern in the stream of data. This result may be seen after applying this consolidation process in FIG. 7.7d, where signals of higher amplitude in the form of vertical lines have appeared. These new signals are spaced in intervals representing the timing of each repetition of the predetermined unique temporal pattern. Therefore, although the individual “on” pulses are still not discernable in the midst of the interference, an indication of the presence and the timing of the signal of interest are discernable.

The information obtained from deep pattern matching may be advantageously utilized by the pattern recognizer 172 (FIG. 4) to lock onto the signal of interest and over time to stay locked onto it in a situation where the interference is greater than would otherwise be possible, with the beneficial result that transmitters 130 at a further distance may be identified and tracked that would otherwise be possible.

In order to disclose this deep pattern matching process more fully, FIG. 7.7e shows how the output of the consolidation process may be produced. FIG. 7.7e shows the same data of the signal of interest and interference as in FIG. 7.7c, as well as the same output as in FIG. 7.7d. One set of arrows 210 shows the historical data values from five previous points in time which have been consolidated to produce their associated output. The time spacings, or “off” periods, between the five points are exactly those of the predetermined unique temporal pattern. The arrow 212 indicates where in the output data stream this particular consolidation occurs. This particular point in time was chosen because it is exactly one of the points when the predetermined unique temporal pattern exactly lines up with the obscured “on” pulses in the incoming data stream, producing a high output signal 214 representing the timing of the predetermined unique temporal pattern. A second set of arrows 216 indicates another set of historical data values from five previous points in time which have been consolidated in exactly the same way as those of the set of arrows 210 and produce the output indicated by arrow 218. The set of data values indicated in the second case differ in that they do not line up with any of the obscured “on” pulses in the incoming data stream and do not produce an indication of the presence of the signal of interest. The same process is repeated at all times as long as the user is actively tracking the signal of interest.

Consolidation of a signal by deep pattern matching is very different from the conventional practice in communications systems in which a relatively brief unique preamble is sent at one time and utilized to acquire signal timing for a packet of data. The deep pattern matching consolidation described in reference to FIG. 7.7e might be loosely described as detection of the pattern of a very long preamble that repeats indefinitely and is followed by no data packet. It is also different in that the strength of the signal and the gain of the receiver is intentionally varied throughout that period of time, rather than held constant. Furthermore, deep pattern matching is also very different from the technique commonly used in well-known communications systems of the transmitter emitting a special timing signal on a known channel which allows the receiver to know in advance where and when to look for the signal of interest, rather than have to sort through all possibilities as is the case with the current invention. In addition, deep pattern matching is very different from the technique commonly used in other types of communications systems wherein the transmitter has access to an absolute time base which is also available to the receiver with which to synchronize the emission of pulses to a schedule as to when and where the receiver will look for them. By contrast, the timing of the current invention is completely arbitrary and no special timing signal is emitted. Moreover, this type of consolidation is not obvious because it is very different from another technique commonly used in other types of communications systems wherein the transmitter is provided with the ability to receive information from the receiver or, in other words, where the link is two-way, or where two units may be referred to as transceivers, rather than simply a transmitter and receiver. One purpose of this two-way capability is typically to exchange timing and other synchronization information, or to perform what may be referred to as a kind of handshaking and obviating the necessity for a locking procedure with a sophisticated and sensitive consolidation scheme such as deep pattern matching as disclosed here. Such a two-way link is obviously convenient for developers but very disadvantageous to the objectives of the current invention of small, battery-powered, long-life and long-range transmitters.

In other embodiments, the signal of interest generated by the transmitter may include “on” pulses and “off” periods, with at least some of the “on” pulses and/or “off” periods having a short duration, or comprising a short interval of time. As used in these contexts, the term “short” may include durations of time that are imperceptible to the human ear or that cannot be discerned efficiently by the human ear. For purposes of this disclosure, durations of time that are 20 milliseconds or less are generally considered to be “short.” Alternatively, durations of about 200 milliseconds or less, about 20 milliseconds or less, about 2 milliseconds or less, about 0.2 milliseconds or about 0.02 milliseconds or less may comprise “short” durations of time. By shortening the pulse duration, it is also possible to proportionally shorten the “off” period in between “on” pulses without increasing battery consumption.

Persons of ordinary skill in the art will be able to design and produce transmitters that generate and transmit signals of the kind just described. In fact, some kinds of existing transmitters may be reprogrammed to enable them to generate and transmit signals with characteristics such as those mentioned in reference to FIG. 7.

Although the preceding disclosure provides many specifics, these should not be construed as limiting the scope of any of the ensuing claims. Other embodiments may be devised which do not depart from the scopes of the claims. Features from different embodiments may be employed in combination. The scope of each claim is, therefore, indicated and limited only by its plain language and the full scope of available legal equivalents to its elements.

1. A differential signal strength direction determination system, comprising:
a transmitter and a receiving device,
the transmitter configured to generate and emit a signal of interest, the signal of interest having a pattern that repeats, the pattern comprising a predetermined unique temporal pattern, the predetermined unique temporal pattern comprising a plurality of “on” pulses separated by “off” periods and including at least one of:
a pattern in which at least two of the “off” periods have unequal durations;
a pattern in which at least two of the “on” pulses have different frequencies;
a pattern in which at least two of the “on” pulses have different phases;
a pattern in which the plurality of “off” periods have the same duration as one another; and
a pattern in which at least two of the “on” pulses have different durations;
the receiving device comprising a directional antenna, a receiver, a processor and an indicator,
the directional antenna:
configured to be pointed in a plurality of directions to receive the signal of interest;
the receiver:
in communication with the directional antenna; and
configured to receive and to process the signal of interest;
the processor:
configured to receive the signal of interest from the receiver; and
programmed to:
compare received signals to the predetermined unique temporal pattern;
detect the signal of interest upon identifying a match between a received signal and the predetermined unique temporal pattern;
determine a plurality of received signal strength indicators (RSSIs) for the signal of interest obtained in the plurality of orientations as the directional antenna is pointed in the plurality of directions;
consolidate two or more amplitudes of the signal of interest that correspond to times, frequencies or phases representing the predetermined unique temporal pattern to provide a signal amplitude indicator by:
performing a pulse RSSI averaging of historical points of the signal of interest where the “on” pulses occur; or
performing a deep pattern match of an entire history of signals from the directional antenna, including points of the signal of interest where the “on” pulses occur and points of the signal of interest where the “off” periods may occur; and
generate and output RSSI signals, each RSSI signal corresponding to a signal amplitude indicator that corresponds to a direction of the plurality of directions in which the directional antenna is pointed; and
the indicator in communication with the processor and configured to:
receive the RSSI signals from the processor; and
provide a user-perceptible output corresponding to the RSSI signals.

2. The differential signal strength direction determination system of claim 1, wherein at least some “on” pulses of the plurality of “on” pulses have durations that are less than a duration that can be effectively detected by a human ear.

3. The differential signal strength direction determination system of claim 1, wherein at least some “off” periods of the plurality of “off” periods have durations that are about 0.2 second or less.

4. The differential signal strength direction determination system of claim 1, wherein the processor of the receiving device is configured to consolidate the two or more amplitudes of the signal of interest by pulse RSSI averaging over a time scale that corresponds to a time scale over which the directional antenna is configured to be moved.

5. The differential signal strength direction determination system of claim 1, wherein the processor of the receiving device is configured to consolidate the two or more amplitudes of the signal of interest by pulse RSSI averaging over a duration of one tenth of a second or more.

6. A differential signal strength direction determination system, comprising:
a transmitter configured to generate and emit a signal of interest;
a receiving device, the receiving device configured to determine a direction to or a location of a source of the signal of interest and including:
a directional antenna;
a receiver in communication with the directional antenna, the directional antenna and the receiver configured to receive the signal of interest;
a processor associated with the receiver, the processor programmed to:
detect the signal of interest;
automatically generate an automatically modified received signal strength indicator (RSSI) scale having a maximum RSSI and a minimum RSSI, the maximum RSSI being less than an absolute maximum RSSI corresponding to a strongest expected RSSI or the minimum RSSI being greater than an absolute minimum RSSI possible;
determine an RSSI for the signal of interest; and
generate an output signal corresponding at least in part to the RSSI and to represent a value of the RSSI relative to the automatically modified RSSI scale;
an indicator in communication with the processor and configured to:
receive the output signal from the processor; and
provide a user-perceptible output corresponding to the output signal on the automatically modified output signal strength scale.

7. The differential signal strength direction determination system of claim 6, wherein the processor of the receiving device is programmed to:
set the minimum RSSI:
based on the maximum RSSI;
as a function of the maximum RSSI;
relative to a weakest possible RSSI for the signal of interest; or
to 1 dB above a maximum unintelligible signal strength; and/or
set the maximum RSSI:
based on the maximum RSSI for the signal of interest detected by the processor during a predetermined period of time;
based on the maximum RSSI for the signal of interest detected by the processor during a most recent period of time during which the directional antennal is moved along a somewhat arcuate path.

8. The differential signal strength direction determination system of claim 6, wherein the processor of the receiving device is programmed to:
calculate an average RSSI of a plurality of RSSIs determined over a calibration period; and
set the maximum RSSI of the RSSI scale based on the composite RSSI.

9. The differential signal strength direction determination system of claim 8, wherein the processor of the receiving device is programmed to:
calculate the average RSSI based on a plurality of RSSIs obtained upon initiating a direction finding session to define a beginning of the calibration period.

10. The differential signal strength direction determination system of claim 6, wherein:
the processor of the receiving device is programmed to:
generate digital representations of the signal of interest as received over a period of time;
calculate a composite of the digital representations of the signal of interest to determine the received signal strength indicator (RSSI) corresponding to the period of time; and
generate an output signal, the output signal corresponding at least in part to the RSSI corresponding to the period of time.

11. The differential signal strength direction determination system of claim 10, wherein the processor of the receiving device is further programmed to:
set or adjust the period of time based on the RSSI of the signal of interest at at least one point in time; or
set or adjust the period of time based on a strength or weakness of the average signal strength.

12. The differential signal strength direction determination system of claim 10, wherein the processor of the receiving device is further programmed to:
generate an output instruction for a user to alter a rate at which the directional antenna is moved.

13. The differential signal strength direction determination system of claim 10, wherein:
the directional antenna of the receiving device is configured to:
be pointed in a plurality of directions to enable the receiver to receive the signal of interest from a plurality of orientations;
the processor of the receiving device is programmed to:
determine a plurality of received RSSIs for the signal of interest obtained in the plurality of orientations as the directional antenna is pointed in the plurality of directions; and
to generate and output RSSI signals, each RSSI signal corresponding to an RSSI that corresponds to a direction of the plurality of directions in which the directional antenna is pointed; and
the indicator is configured to:
receive the RSSI signals from the processor; and
provide a user-perceptible output corresponding to each RSSI signal.

14. The differential signal strength direction determination system of claim 6, wherein the receiving device is configured to be held by a single hand of an individual.

15. A differential signal strength direction determination system, comprising:
a transmitter, the transmitter configured to generate and emit a signal of interest; and
a receiving device, the receiving device configured to determine a direction to or a location of a source of the signal of interest and including:
a directional antenna;
a receiver in communication with the directional antenna, the directional antenna and the receiver configured to receive the signal of interest;
a processor associated with the receiver, the processor programmed to:
detect the signal of interest;
determine a received signal strength indicator (RSSI) of the signal of interest;
based on a fixed scale of RSSIs, provide an estimated distance between the receiving device and the transmitter; and
generate an output signal comprising an indicator of the estimated distance between the receiving device and the transmitter; and
an indicator in communication with the processor and configured to:
receive an output signal from the processor; and
provide a user-perceptible output corresponding to the estimated distance between the receiving device and the transmitter.

16. The differential signal strength direction determination system of claim 15, wherein the processor of the receiving device is programmed to:
provide the estimated distance between the receiving device and the transmitter based on a most recently determined RSSI.

17. The differential signal strength direction determination system of claim 15, wherein the processor of the receiving device is programmed to:
determine the signal strength by calculating a composite RSSI for a period of time.

18. The differential signal strength direction determination system of claim 15, wherein the processor of the receiving device is programmed to:
determine the RSSI by automatically compensating for an adjustment to a gain of the receiver.

19. The differential signal strength direction determination system of claim 15, wherein the receiving device is configured to be held by a single hand of an individual.
